(19) United States
(12) Patent Application Publication
(10) Pub. No.: US 2002/0094993 A1
(43) Pub. Date: Jul. 18, 2002

(54) Compositions for repelling crawling insects

(76) Inventors: Hans-Jurgen Schnorbach, Monheim (DE); Rolf Jung, Koln (DE); Klaus Roder, Leverkusesn (DE); Frank Michelis, Leverkusen (DE); Bernd-Wieland Kruger, Bergish Gladbach (DE)

Correspondence Address: Jeffrey M. Greenman, Vice President, Patents and Licensing, Bayer Corporation, 400 Morgan lane, West Haven, CT, 06516, US

(21) Appl. No.: 09/906,202

(22) Filed: Jul. 16, 2001

(30) Foreign Application Priority Data
Jul. 14, 2000 (DE) 10034396.1

(51) Int. Cl. A01N 43/00; A01N 43/40; A01N 37/10; A01N 35/00

(52) U.S. Cl. 514/330; 514/568; 514/699; 514/161

(57) ABSTRACT

The present invention relates to novel compositions, comprising a repellent and an additive, where the additive is selected from the group consisting of phenol, benzaldehyde, benzoic acid or derivatives thereof and is present in a ratio of from 10:100 to 200:100% by weight to the repellent, and to their use for repelling crawling harmful insects, in particular ants or cockroaches.

The present invention relates to novel compositions and to their use for repelling crawling insects.

Crawling insects in and around areas of human residence are usually controlled with insecticidally active compounds. To this end, the insects are either treated directly with the products, or they come into contact with the products via residual surfaces, or the active compounds are taken up orally via baits. The insecticidally active compounds have to be applied in the immediate residence area, a fact which causes negative sentiments in many people since insecticides are associated with toxic side-effects.

Mechanical measures, such as used, for example, against flying insects, e.g. fly netting, wire-screens or electric traps, can usually not be used against crawling insects, since they can be crossed, don't work or work only insufficiently (e.g. electric traps).

In principle, it should be possible to keep harmful insects away from areas of human residence using virtually nontoxic repellents. However, repellents which repel crawling insects such as ants or cockroaches have hitherto not attained much importance in practice, since the known repellents are volatile, thus only acting for a very limited period of time. The action of the known repellents against crawling insects is low.

It is known that parasitic harmful insects and mites, such as, for example, mosquitos, flies or ticks, are repelled by repellents that are applied to the skin (cf., for example, Gupta R. K, Rutledge I. C., Role of repellents in vector control and disease prevention, Am. J. Trop. Med. Hyg. 50 (1995), 82-86). Known repellents are, for example, N,N-diethyl-m-toluamide (DEET, I) (McCabe E. T., Barthel W. F., Gertler S. L., Hall S. A., Insect repellents, III. N,N-Diethylamides, J. Org. Chem. 19 (1954), 493-498), Merck 3535 (IR 3535, II) (Klier M., Kuhlow F., Neue Insektenabwehrmittel- am Stickstoff substituierte β-Alaninderivate [Novel insect repellents-nitrogen-substituted β-alanine derivatives], J. Soc. Cosmet. Chem. 27 (1976), 141- 153) and 1-(2-methylpropyloxycarbonyl)-2-(hydroxyethyl)-piperidine (KBR 3023, Bayrepel®, III) (Boeck J. et al., Pestic. Sci. 48 (1996), 359-373):

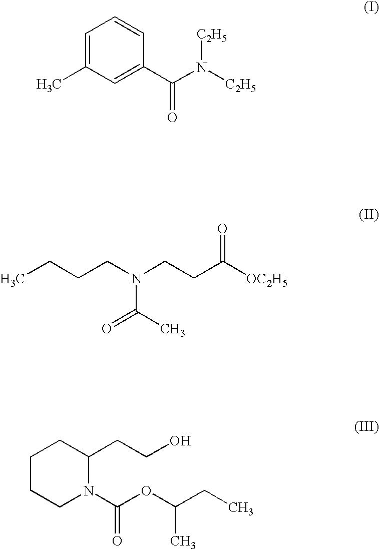

These repellents, too, act only for a few hours against crawling insects such as, for example, ants and cockroaches, since the active compounds are relatively volatile at room temperature. Moreover, DEET attacks various plastics and, owing to its incompatibility with these materials, is not suitable for this indication.

It is known that a combination of DEET and vanillin has a prolonged repellent effect on flying insects such as mosquitos (Khan A. A, Maibach H. I., Skidmore D. L., Mosq. News 35 (1975), 223-225). This combination has also been used for repelling lice, but a longer duration of action compared to DEET on its own has not been described (EP-A-0 557 174). Moreover, in JP-A-0 517 0603, combinations of DEET with various substances such as, for example, salicylic acid derivatives have been used for repelling flying insects, such as, for example, mosquitos (Aedes albopictus skuse). However, these publications do not mention that such compositions have a long-lasting repellent effect on crawling harmful insects.

It is an object of the present invention to provide a composition for controlling crawling harmful insects which does not have the disadvantages of the repellents and insecticides described above.

According to the invention, this object is achieved by compositions according to claim 1. These compositions comprise a repellent and an additive selected from the group consisting of phenol, benzoic acid and derivatives thereof.

Surprisingly, it has been found that the action of repellents against crawling insects can be prolonged to a degree which was unforeseeable, by mixing these repellents with one of the above additives. Repellent and additive act synergistically, resulting in the more than proportional prolongation of action. This effect can not be explained by an inhibition of the evaporation of the repellent by the additive alone.

Repellents which can be used according to the invention are all compounds having a repellent effect on crawling insects. Preference is given to DEET, IR 3535 and Bayrepel®, and particular preference according to the invention is given to Bayrepel®.

Suitable additives for the compositions according to the invention are: phenol, benzaldehyde, benzoic acid and their derivatives, such as, for example:

Hydroxy compounds of the abovementioned aromatic phenols/aldehydes/carboxylic acids, such as, for example, o-, m-, p-hydroxyphenol/-benzaldehyde/-benzoic acid or 2,4-dihydroxyphenol/-benzaldehyde/-benzoic acid or 2,4,6-trihydroxyphenol/-benzaldehyde/-benzoic acid or 1,4-dihydroxynaphthalene or 4-hydroxynapthaldehyde or 4-hydroxynaphthoic acid or 2,4-diformylnaphthol or 2,4-diformylnaphthoic acid or 2,4-dihydroxynaphthaldehyde or 2,4-dihydroxynaphtoic acid, and also their phenolates, such as, for example, 4-hydroxyphenolate, 4-formylphenolate, 4-carboxyphenolate or 4-formylnaphtholate or 4-carboxynaphtholate, and also their analogous benzoates, such as, for example, 4-hydroxybenzoate or 4-formylbenzoate or 4-hydroxynaphthoate or 4-formylnaphthoate.

Aldehyde derivatives of the abovementioned aromatic phenols/aldehydes/carboxylic acids, such as, for example, o-, m-, p-formylphenol/-benzaldehyde/-benzoic acid or 2,4-diformylphenol/-benzaldehyde/-benzoic acid and also their salts, such as, for example, 2,4-diformyl phenolate/-benzoate.

Carboxylic acid derivatives of the abovementioned aromatic phenols/aldehydes/carboxylic acids, such as, for example, 4-formylbenzoic acid or 2-hydroxybenzoic acid or 1,4-benzenedicarboxylic acid or 4-hydroxybenzene-1,2-dicarboxylic acid or 4-formylbenzene-1,2-dicarboxylic acid or 2-hydroxybenzenetricarboxylic acid or 2-formylbenzenetricarboxylic acid or benzenetricarboxylic acid or 1,4-naphthalenedicarboxylic acid or 4-hydroxynaphthalene-1,2-dicarboxylic acid or 4-formylnaphthalene-1,2-dicarboxylic acid or 2-hydroxynaphthalene-1,4,6-tricarboxylic acid or 2-formylnaphthalene-1,4,6-tricarboxylic acid or naphthalene-1,4,6-tricarboxylic acid.

Nitrile derivatives of the abovementioned aromatic phenols/aldehydes/carboxylic acids, such as, for example, 2-formylbenzonitrile or 2-hydroxybenzonitrile or 2-carboxybenzonitrile or 2-formyl-1,4-benzodinitrile or 2-hydroxy-1,4-benzodinitrile or 2-carboxy-1,4-benzodinitrile or 2-formylnapthonitrile or 2-hydroxynaphthonitrile or 2-carboxynaphthonitrile or 2-formyl-1,4-naphthodinitrile or 2-hydroxy-1,4-naphthodinitrile or 2-carboxy-1,4-naphthodinitrile.

Carboxylic acid halide derivatives of the abovementioned aromatic phenols/aldehydes/carboxylic acids, such as, for example, 2-formylbenzenecarboxylic acid chloride or 2-hydroxybenzenecarboxylic acid bromide or benzene-1,2-dicarboxylic acid chloride or 2-formylbenzene-1,4-dicarboxylic acid dichloride or 2-hydroxybenzene-1,4-dicarboxylic acid dichloride or benzene-1,3,5-tricarboxylic acid dichloride or 2-formylnapthalenecarboxylic acid chloride or 2-hydroxynaphthalenecarboxylic acid bromide or naphthalene-1,2-dicarboxylic acid chloride or 2-formylnaphthalene-1,4-dicarboxylic acid dichloride or 2-hydroxynaphthalene-1,4-dicarboxylic acid dichloride or naphthalene-1,3,5-tricarboxylic acid dichloride.

Carboxylic acid ester derivatives of the abovementioned aromatic phenols/aldehydes/carboxylic acids, such as, for example, dibutyl 4-hydroxybenzene-1,2-dicarboxylate or dibutyl 4-hydroxybenzene-1,2-dicarboxylate or dibutyl 4-formylbenzene-1,2-dicarboxylate or mixed forms thereof, such as, for example, methyl butyl 4-hydroxybenzene-1,2-dicarboxylate or methyl butyl 4-formylbenzene-1,2-dicarboxylate, and also the analogous benzene derivatives, such as, for example, benzyl 4-hydroxybenzoate or benzyl 4-formylbenzoate or benzyl 4-carboxybenzoate or substituted derivatives thereof, such as, for example, 2-chlorobenzyl 4-formylbenzoate or 2-chlorobenzyl 4-hydroxybenzoate or 2-chlorobenzyl 4-carboxybenzoate, and also the analogous phenyl derivatives, such as, for example, phenyl 4-hydroxybenzoate or phenyl 4-formylbenzoate or phenyl 4-carboxybenzoate or 2-chlorophenyl 4-hydroxybenzoate or substituted derivatives thereof, such as, for example, 2-chlorophenyl 4-formylbenzoate or 2-chlorophenyl 4-carboxybenzoate, and also the analogous naphthyl derivatives, such as, for example, naphthyl 4-hydroxybenzoate or naphthyl 4-formylbenzoate or naphthyl 4-carboxybenzoate or substituted derivatives thereof, such as, for example, 2-chloronaphthyl 4-hydroxybenzoate or 2-chloronaphthyl 4-formylbenzoate or 2-chloronaphthyl 4-carboxybenzoate or 2′-chloro-4-hydroxybenzoic acid 1-methylnaphthalene ester or 2′-chloro-4-formylbenzoic acid 1-methylnaphthalene ester or 2′-chloro-1,4-dicarboxybenzene 1-methylnaphthalene ester.

Carboxamide derivatives of the abovementioned aromatic phenols/aldehydes/carboxylic acids, such as, for example, 4-hydroxybenzamide or 4-formylbenzamide or 4-carboxybenzamide or benzenetricarboxylic acid mono-/diamide or 4-hydroxynaphthalamide or 4-formylnaphthalamide or 4-carboxynaphthalamide or naphthalenetricarboxylic acid mono-/diamide, and also the derivatives of the mono- or poly-N-substituted carboxamides, such as, for example, N-acetyl-4-hydroxybenzamide or N-acetyl-4-formylbenzamide or N-acetyl-1,4-dibenzamide or N-phenyl-4-hydroxybenzamide or N-phenyl-4- formylbenzamide or N-phenyl-1,4-dibenzoic acid monoamide or N-naphthyl-4-formylbenzamide or N-naphthyl-4-hydroxybenzamide or N-naphthyl-1,4-dibenzoic acid monoamide or N,N-diacetyl-4-formylbenzamide or N,N-diacetyl-4-hydroxybenzamide or N,N-diacetyl-1,4-dibenzoic acid monoamide or N-acetyl-4-hydroxynaphthalamide or N-acetyl-4-formylnaphthalamide or N-acetyl-1,4-dinaphthalamide or N-phenyl-4-hydroxynaphthalamide or N-phenyl-4-formylnaphthalamide or N-phenyl-1,4-dinaphthoic acid monoamide or N-naphthyl-4-formylnaphthalamide or N-naphthyl-4-hydroxynaphthalamide or N-naphthyl-1,4-dinaphthoic acid monoamide or N,N-diacetyl-4-formylnaphthalamide or N,N-diacetyl-4-hydroxynaphthalamide or N,N-diacetyl-1,4-dinaphthoic acid monoamide.

Anhydride derivatives of the abovementioned aromatic phenols/aldehydes/carboxylic acids, such as, for example, 4-hydroxy-1,2-benzenedicarboxylic acid anhydride or 4-formyl-1,2-benzenedicarboxylic acid anhydride or 1,2,4-tribenzoic acid anhydride or 4-hydroxybis-(1,2-dibenzoic acid) anhydride or 4,4′-dihydroxybis-(1,2-dibenzoic acid) anhydride or 4-formylbis-(1,2-dibenzoic acid) anhydride or 4,4′-diformylbis-(1,2-benzoic acid) anhydride or 2,2′-dihydroxybis-(1,3,5-tribenzoic acid) anhydride or 2,2′-diformylbis-(1,3,5-tribenzoic acid) anhydride or (4-hydroxy-1,2-benzoic acid) benzoic acid anhydride or 4-hydroxybenzoic acid malonic acid anhydride or naphthalenecarboxylic acid 4-hydroxy-1,2-dibenzoic acid anhydride or naphthalenecarboxylic acid 4-formyl-1,2-dibenzoic acid anhydride or di-(naphthalenecarboxylic acid) 4-formyl-1,5-benzoic acid dianhydride or di-(naphthalenecarboxylic acid) 4-hydroxy-1,5-benzoic acid dianhydride or 2-naphthylamine-4-carboxylic acid 4′-formyl-1,2-dibenzoic acid anhydride or 2-naphthylamine-4-carboxylic acid 4′-hydroxy-1,2-dibenzoic acid anhydride or 4-formyl-1,2-naphthalenedicarboxylic acid anhydride or 1,2,4-trinaphthoic acid anhydride or 4-hydroxybis-(1,2-dinaphthoic acid) anhydride or 4,4′-dihydroxybis-(1,2-dinaphthoic acid) anhydride or 4-formylbis-(1,2-dinaphthoic acid) anhydride or 4,4′-diformylbis-(1,2-naphthoic acid) anhydride or 2,2′-dihydroxybis-(1,3,5-trinaphthoic acid) anhydride or 2,2′-diformylbis-(1,3,5-trinaphthoic acid) anhydride or (4-hydroxy-1,2-naphthoic acid) naphthoic acid anhydride or 4-hydroxynaphthoic acid malonic acid anhydride or naphthalenecarboxylic acid 4-hydroxy-1,2-dinaphthoic acid anhydride or naphthalenecarboxylic acid 4-formyl-1,2-dinaphthoic acid anhydride or bis-(naphthalenecarboxylic acid) 4 formyl-1,5-naphthoic acid dianhydrid or bis-(naphthalenecarboxylic acid) 4-hydroxy-1,5-naphthoic acid dianhydride or 2-naphthylamine-4-carboxylic acid 4′-formyl-1,2-dinaphthoic acid anhydride or 2-naphthylamine-4-carboxylic acid 4′-hydroxy-1,2-dinaphthoic acid anhydride.

Benzoate derivatives of the abovementioned aromatic phenols/aldehydes/carboxylic acids, such as, for example, sodium 4 formylbenzoate or sodium 4-hydroxybenzoate or 1,4-dibenzoic acid monosodium salt or 4-hydroxy-1,2-dibenzoic acid monosodium salt or 4-formyl-1,2-dibenzoic acid monosodium salt or 4-hydroxy-1,3-dibenzoic acid disodium salt or 4-formyl-1,3-dibenzoic acid disodium salt or sodium 4-formylnaphthoate or sodium 4-hydroxynaphthoate or 1,4-dinaphthoic acid monosodium salt or 4-hydroxy-1,2-dinaphthoic acid monosodium salt or 4-formyl-1,2-dinaphthoic acid monosodium salt or 4-hydroxy-1,3-dinaphthoic acid disodium salt or 4-formyl-1,3-dinaphthoic acid disodium salt, and also the analogous mono- and disalts of the mono- and polycarboxylic acid esters, such as, for example, 4-formyl-1,3-dibenzoic acid monobutyl ester sodium salt or 4-hydroxy-1,3-dibenzoic acid monobutyl ester sodium salt or 1,4-dibenzoic acid monobutyl ester sodium salt or 4-formyl-1,3-dinaphthoic acid monobutyl ester sodium salt or 4-hydroxy-1,3-dinaphthoic acid monobutyl ester sodium salt or 1,4-dinaphthoic acid monobutyl ester sodium salt.

Hydrazide derivatives of the abovementioned aromatic phenols/aldehydes/carboxylic acids, such as, for example, 2-hydroxybenzoic acid hydrazide or 2-formylbenzoic acid hydrazide or 1,2-benzenedicarboxylic acid monohydrazide or 1,3,5-benzenetricarboxylic acid mono-/di-/trihydrazide or 2-hydroxy-1,3,5-benzenetricarboxylic acid mono-/di-/trihydrazide or 2-formyl-1,3,5-benzenetricarboxylic acid mono-/di-/trihydrazide or 2-formylbenzoic acid phenylhydrazine or 2-hydroxybenzoic acid phenylhydrazine or 1,3-benzenedicarboxylic acid monophenylhydrazine or 2-hydroxynaphthoic acid hydrazide or 2-formylnaphthoic acid hydrazide or 1,2-naphthalenedicarboxylic acid monohydrazide or 1,3,5-naphthalenetricarboxylic acid mono-/di-/trihydrazide or 2-hydroxy-1,3,5-naphthalenetricarboxylic acid mono-/di-/trihydrazide or 2-formyl-1,3,5-naphthalenetricarboxylic acid mono-/di-/trihydrazide or 2-formylnaphthoic acid phenylhydrazine or 2-hydroxynaphthoic acid phenylhydrazine or 1,3-naphthalenedicarboxylic acid monophenylhydrazine.

Hydroxamic acid derivatives of the abovementioned aromatic phenols/aldehydes/carboxylic acids, such as, for example, 2-hydroxybenzohydroxamic acid or 2-formylbenzohydroxamic acid or 2-carboxybenzohydroxamic acid or benzenetricarboxylic acid dihydroxamic acid or 2-hydroxybenzenetricarboxylic acid mono-/di-/trihydroxamic acid or 2-formylbenzenetricarboxylic acid mono-/di-/trihydroxamic acid or 2-hydroxynaphthohydroxamic acid or 2-formyl-naphthohydroxamic acid or 2-carboxynaphthohydroxamic acid or naphthalenetricarboxylic acid dihydroxamic acid or 2-hydroxynaphthalenetricarboxylic acid mon-/di-/trihydroxamic acid or 2-formylnaphthalenetricarboxylic acid mono-/di-/trihydroxamic acid.

Halogen compounds of the abovementioned aromatic phenols/aldehydes/carboxylic acids, such as, for example, 2,4-dichlorophenol/benzaldehyde/benzoic acid or 2,4-difluorophenol/benzaldehyde/benzoic acid or 2,4-dibromophenol/benzaldehyde/benzoic acid.

Alkyl, alkenyl, alkinyl compounds of the abovementioned aromatic phenols/aldehydes/carboxylic acids, such as, for example, 2,4-dimethylphenol/benzaldehyde/benzoic acid or o-, m-, p-vinylphenol/benzaldehyde/benzoic acid or, for example, 4-hydroxy-α,β-diphenylethylene, α-(4-formylphenyl)-β-vinylbenzene, α-(4-carboxyphenyl)-β-vinylbenzene or 4-trifluoromethylphenol/benzaldehyde/benzoic acid, 3-(β-chloroethylene)phenol/benzaldehyde/benzoic acid or 2,4-dimethylnaphthol/naphthaldehyde/naphthoic acid or 2-, 3-, 4-vinylnaphthol/naphthaldehyde/naphthoic acid or, for example, 4-hydroxy-α, β-di-naphthylethylene, α-(4-formylnaphthyl)-β-vinylbenzene, α-(4-carboxyphenyl)-β-vinylbenzene or 4-trifluoromethylnaphthol/naphthaldehyde/naphthoic acid, 3-(β-chloroethylene)naphthol/naphthaldehyde/naphthoic acid.

Ethers of the abovementioned aromatic phenols/aldehydes/carboxylic acids, such as 4-methoxyphenol/benzaldehyde/benzoic acid and their mono- or poly-unsaturated derivatives, such as, for example, 4-(prop-2-ene)oxyphenol/benzaldehyde/benzoic acid or 4-hydroxy-3-methoxybenzaldehyde or 4-hydroxy-3-methoxybenzoic acid or 4-hydroxyphenyl phenyl ether or 4-formylphenyl phenyl ether or 4-carboxyphenyl phenyl ether or di(4-hydroxyphenyl) ether or di(4-formylphenyl)ether or di(4-carboxyphenyl)ether or 4-formylphenyl 4-hydroxyphenyl ether or 4-formylphenyl 4-carboxyphenyl ether or 4-hydroxyphenyl 4-carboxyphenyl ether or 2-formyl-4-hydroxyphenyl 4-carboxyphenyl ether or 4-hydroxy-2-formylphenyl 4-hydroxyphenyl ether or 4-hydroxy-2-carboxyphenyl 4-hydroxyphenyl ether or 4-formyl-2-hydroxyphenyl 4-formylphenyl ether or 4-formyl-2-carboxyphenyl 4-formylphenyl ether or 4-carboxy-2-hydroxyphenyl 4-carboxyphenyl ether or 4-carboxy-2-formylphenyl 4-carboxyphenyl ether or 2-formylphenyl 2-hydroxy-4-carboxyphenyl ether or 4-hydroxyphenyl naphth-1-yl ether or 4-formylphenyl naphth-2-yl ether or 4-carboxyphenyl naphth-1-yl ether or 4-hydroxyphenyl 2-hydroxynaphth-1-yl ether or 4-formylphenyl 1-formylnaphth-2-yl ether or 4-carboxyphenyl 2-carboxynaphth-1-yl ether or 4-formylphenyl 4-hydroxynaphth-2-yl ether or 4-formylphenyl 2-carboxynaphth-1-yl ether or 4-hydroxyphenyl 4-carboxynaphth-2-yl ether or 2-formyl-4-hydroxyphenyl 4-carboxynaphth-1-yl ether or 4-hydroxyphenyl 2-formyl-4-hydroxynaphth-1-yl ether or 4-hydroxyphenyl 2-carboxy-4-hydroxynaphth-1-yl ether or 4-formylphenyl 2-hydroxy-4-formylnaphth-1-yl ether or 4-formylphenyl 2-carboxy-4-formylnaphth-1-yl ether or 4-carboxyphenyl 2-hydroxy-4-carboxynaphth-1-yl ether or 4-carboxyphenyl 2-formyl-4-carboxynaphth-1-yl ether or 4-hydroxynaphth-1-yl naphth-1-yl ether or 4-formylnaphth-1-yl naphth-2-yl ether or 4-carboxynaphth-1-yl naphth-1-yl ether or 4-hydroxynaphth-1-yl 4-hydroxynaphth-2-yl ether or 4-formylnaphth-1-yl 4-formylnaphth-2-yl ether or 4-carboxynaphth-1-yl 4-naphth-2-yl ether or 4-formylnaphth-1-yl 4-hydroxynaphth-1-yl ether or 4-formylnaphth-1-yl 4-carboxynaphth-2-yl ether or 4-hydroxynaphth-2-yl 4-carboxynaphth-1-yl ether or 2-formyl-4-hydroxynaphth-1-yl 4-carboxynaphth-2-yl ether or 4-hydroxy-2-formylnaphth-2-yl formylhydroxynaphth-1-yl ether or 4-hydroxy-2-carboxynaphth-1-yl 4-hydroxynaphth-1-yl ether or 4-formyl-2-hydroxynaphth-1-yl 4-formylnaphth-1-yl ether or 4-formyl-2-carboxynaphth-1-yl 4-formylnaphth-1-yl ether or 4-carboxy-2-hydroxynaphth-1-yl 4-carboxynaphth-1-yl ether or 4-carboxy-2-formylnaphth-1-yl 4-carboxynaphth-1-yl ether.

Keto compounds of the abovementioned aromatic phenols/aldehydes/carboxylic acids, such as 4-formylbenzoyl chloride or 4-hydroxybenzoyl chloride or 4-carboxybenzoyl chloride or 4-hydroxybenzophenone/4-formylbenzophenone, 4-carboxybenzophenone or 2-hydroxy-(α-hydroxy-α-phenyl)acetophenone or 2,2′-dihydroxy-(α-hydroxy-α-phenyl)acetophenone or 2-formyl-(α-hydroxy-α-phenyl)acetophenone or 2,2′-diformyl-(α-hydroxy-α-phenyl)acetophenone or 2-carboxy-(α-hydroxy-α-phenyl)acetophenone or 2,2′-dicarboxy-(α-hydroxy-α-phenyl)acetophenone or 2′-hydroxy-2-formyl-(α-hydroxy-α-phenyl)acetophenone or 2-hydroxy-3-formyl-(α-hydroxy-α-phenyl)acetophenone or 2′-carboxy-2-hydroxy-(α-hydroxy-α-phenyl)acetophenone or 2-carboxy-3-hydroxy-(α-hydroxy-α-phenyl)acetophenone or 2′-carboxy-2-formyl-(α-hydroxy-α-phenyl)acetophenone or 2-carboxy-3-formyl-(α-hydroxy-α-phenyl)acetophenone or 4-hydroxyphenyl naphth-2-yl ketone or 4-formylphenyl naphth-1-yl ketone or 4-carboxyphenyl naphth-1-yl ketone or 4-hydroxyphenyl 2-formylnaphth-1-yl ketone or 4-hydroxyphenyl 4-carboxynaphth-2-yl ketone or 4-formylphenyl 4-hydroxynaphth-1-yl ketone or 4-formylphenyl 4-carboxynaphth-2-yl ketone or 4-hydroxyphenyl) 2-hydroxynaphth-1-yl ketone or 4-formylphenyl 4-formylnaphth-2-yl ketone or 4-carboxyphenyl 4-carboxynaphth-2-yl ketone or 2-formyl-4-hydroxyphenyl naphth-2-yl ketone or 2-carboxy-4-hydroxyphenyl naphth-1-yl ketone or 2,4-dihydroxyphenyl naphth-1-yl ketone or 2,4-diformylphenyl) naphth-2-yl ketone or 2,4-dicarboxyphenyl naphthyl ketone or 4-hydroxyphenyl 4-carboxy-6-formylnaphth-1-yl ketone or 4-formylphenyl 4-carboxy-6-hydroxynaphth-1-yl ketone or 4-carboxyphenyl 4-formyl-6-hydroxynaphth-1-yl ketone or 4-hydroxynaphth-1-yl naphth-1-yl ketone or 4-formylnaphth-1-yl naphth-2-yl ketone or 4-carboxynaphth-1-yl naphth-1-yl ketone or 3-formyl-4-hydroxynaphth-1-yl naphth-2-yl ketone or 3-formyl-4-carboxynaphth-1-yl naphth-1-yl ketone or 3-carboxy-4-hydroxynaphth-1-yl naphth-1-yl ketone or 4-hydroxynaphth-1-yl 4-hydroxynaphth-2-ylketone or 4-formylnaphth-1-yl 4-formylnaphth-2-yl ketone or di-(4-carboxynaphth-1-yl) ketone or 2-hydroxynaphth-1-yl 4-formylnaphth-1-yl ketone or 3-carboxynaphth-1-yl 4-formylnaphth-2-yl ketone or 4-hydroxy-6-carboxynaphth-1-yl naphth-1-yl ketone.

Urea derivatives of the abovementioned aromatic phenols/aldehydes/carboxylic acids, such as, for example, 2-hydroxyphenylurea or 2-formylphenylurea or 2-carboxyphenylurea or 2-hydroxy-4-formylphenylurea or 2-hydroxy-4-carboxyphenylurea or 2-formyl-4-carboxyphenylurea or 2,4-dihydroxyphenylurea or 2,4-diformylphenylurea or 2,4-dicarboxyphenylurea or N,N′-(2-hydroxy)diphenylurea or N,N′-(2-formyl)diphenylurea or N,N′-(2-carboxy)diphenylurea or N,N′-(2,4-dihydroxy)diphenylurea or N,N′-(2,4-diformyl)diphenylurea or

N,N′-(2,4-dicarboxy)diphenylurea or N,N′-(2,2′-dihydroxy)diphenylurea or N,N′-(2,4′-diformyl)diphenylurea or N,N′-(2,4′-dicarboxy)diphenylurea or N,N′-(2,2′-dihydroxy-4-formyl)diphenylurea or N,N′-(2,4′-diformyl-2-hydroxy)diphenylurea or N,N′-(2,4′-dicarboxy-4-formyl)diphenylurea or N,N′-(2-hydroxy-2′-formyl-3-carboxy)diphenylurea or 2-hydroxynaphthylurea or 2-formylnaphthylurea or 2-carboxynaphthylurea or 2-hydroxy-4-formylurea or 2-hydroxy-4-carboxynaphthyl-1-urea or 2-formyl-4-carboxynaphthyl-1-urea or 2,4-dihydroxynaphthylurea or 2,4-diformylnaphthylurea or 2,4-dicarboxynaphthylurea or N,N′-(2-hydroxy)dinaphthylurea or N,N′-(2-formyl)dinaphthylurea or N,N′-(2-carboxy)dinaphthylurea or N,N′-(2,4-dihydroxy)dinaphthylurea or N,N′-(2,4-diformyl)dinaphthylurea or N,N′-(2,4-dicarboxy)dinaphthylurea or N,N′-(2,2′-dihydroxy)dinaphthylurea or N,N′-(2,4′-diformyl)dinaphthylurea or N,N′-(2,4′-dicarboxy)dinaphthylurea or N,N′-(2,2′-dihydroxy-4-formyl)dinaphthylurea or N,N′-(2,4′-diformyl-2-hydroxy)dinaphthylurea or N,N′-(2,4′-dicarboxy-4-formyl)dinaphthylurea or N,N′-(2-hydroxy-2′-formyl-3-carboxy)dinaphthylurea.

Amine derivatives of the abovementioned phenols/aldehydes/carboxylic acids, such as, for example, o-, m-, p-aminophenol/benzaldehyde/benzoic acid or 2,4-diaminophenol/benzaldehyde/benzoic acid or 2-aminonaphthol/naphthaldehyde/napthoic acid or 2,4-diaminonaphthol/naphthaldehyde/naphthoic acid.

Imide derivatives of the abovementioned aromatic phenols/aldehydes/carboxylic acids, such as, for example, 4-hydroxybenzaldimine or 2-formylbenzaldimine or 4-carboxybenzaldimine or 4-hydroxynaphthaldimine or 2-formylnaphthaldimine or 4-carboxynaphthaldimine.

Ketimine derivatives of the abovementioned aromatic phenols/aldehydes/carboxylic acids, such as, for example, 2-hydroxyphenyl methyl ketimine or 4-formylphenyl methylketimine or 3-carboxyphenyl methyl ketimine or 2-hydroxyphenyl phenyl ketimine or 4-formylphenyl phenyl ketimine or 3-carboxyphenyl phenyl ketimine or di-(2-dihydrophenyl) ketimine or di-(4-formylphenyl) ketimine or di-(3-carboxyphenyl) ketimine or 2-formylphenyl 2-hydroxyphenyl ketimine or 2-formylphenyl 2-carboxyphenyl ketimine or 2-hydroxyphenyl 4-carboxyphenyl ketimine or 2-hydroxyphenyl naphth-2-yl ketimine or 4-formylphenyl napth-2-yl ketimine or 3-carboxyphenyl napth-1-yl ketimine or 2-hydroxyphenyl 2-hydroxynapth-1-yl ketimine, or 4-formylphenyl 4-formylnaphth-2-yl ketimine, or 3-carboxyphenyl 3-carboxynaphth-2-yl ketimine, or 4-formylphenyl 2-hydroxynaphth-1-yl ketimine, or 4-formylphenyl 3-carboxynaphth-2-yl ketimine, or 4-hydroxyphenyl 2-carboxynaphth-1-yl ketimine, or 4-carboxyphenyl 2-hydroxynaphth-1-yl ketimine, or 4-carboxyphenyl 1-formylnaphth-2-yl ketimine

Imino acid derivatives of the abovementioned aromatic phenols/aldehydes/carboxylic acids, such as, for example, α-carboxy-4-hydroxybenzylimine or α-carboxy-4-formylbenzylimine or α-carboxy-4-carboxybenzylimine or α-carboxy-4-hydroxynaphthylimine or α-carboxy-4-formylnaphthylimine or α-carboxy-4-carboxynaphthylimine, and their salts, such as, for example, α-carboxy-4-hydroxybenzylimine sodium salt or α-carboxy-4-formylbenzylimine sodium salt or α-carboxy-4-carboxybenzylimine monosodium salt or α-carboxy-4-hydroxynaphthylimine sodium salt or α-carboxy-4-formylnaphthylimine sodium salt or α-carboxy-4-carboxynaphthylimine monosodium salt or β-carboxy-α-(4-hydroxy-phenyl)-β-ethylimine or β-carboxy-α-(4-formylphenyl)-α-ethylimine or α-carboxy-α-(4-carboxy-phenyl)-β-propylimine or β-carboxy-α-(4-hydroxynaphthyl)-β-ethylimine or β-carboxy-α-(4-formylnaphthyl)-α-ethylimine or α-carboxy-α-(4-carboxy-naphthyl)-β-propylimine, and their salts, such as, for example, β-carboxy-α-(4-hydroxyphenyl)-β-ethylimine sodium salt or β-carboxy-α-(4-formylphenyl)-α-ethylimine sodium salt or α-carboxy-α-(4-carboxyphenyl)-β-propylimine monosodium salt or β-carboxy-α-(4-hydroxynaphthyl)-β-ethylimine sodium salt or β-carboxy-α-(4-formylnaphthyl)-α-ethylimine sodium salt or α-carboxy-α-(4-carboxynaphthyl)-β-propylimine monosodium salt.

Imino ester derivatives of the abovementioned aromatic phenols/aldehydes/carboxylic acids, such as, for example, methyl α-carboxy-4-hydroxybenzylimidate or phenyl α-carboxy-4-hydroxybenzylimidate or methyl α-carboxy-4-formylbenzylimidate or phenyl α-carboxy-4-formylbenzylimidate or α-methyl α-carboxy-4-carboxybenzylimidate or α-phenyl α-carboxy-4-carboxybenzylimidate or α-(4-formyl)phenyl α-carboxy-4-hydroxybenzylimidate or α-(2-formyl)phenyl α-carboxy-4-formylbenzylimidate or α-(3-hydroxy)phenyl α-carboxy-4-hydroxybenzylimidate or α-(4-carboxy)phenyl α-carboxy-4-carboxybenzylimidate or naphth-1-yl α-carboxy-4-hydroxybenzylimidate or naphth-2-yl α-carboxyl-4-formylbenzylimidate or naphth-1-yl α-carboxyl-4-formylbenzylimidate or α-naphth-1-yl α-carboxyl-4-carboxybenzylimidate or α-naphth-1-yl α-carboxy-4-carboxybenzylimidate or α-(4-formyl)naphth-2-yl α-carboxy-2-hydroxybenzylimidate or α-(2-formyl)naphth-1-yl α-carboxy-4-formylbenzylimidate or α-(3-hydroxy)naphth-1-yl α-carboxy-4-hydroxybenzylimidate or α-(4-carboxy)naphth-2-yl α-carboxy-4-carboxybenzylimidate.

Imino ether derivatives of the abovementioned phenols/aldehydes/carboxylic acids, such as, for example, 4-hydroxybenzoyl methyl imino ether or 4-formylbenzoyl methyl imino ether or 4-carboxybenzoyl methyl imino ether or 4-hydroxybenzoyl phenyl imino ether or 4-hydroxynaphthoyl methyl imino ether or 4-formylnaphthoyl methyl imino ether or 4-carboxynaphthoyl methyl imino ether or 4-hydroxybenzoyl phenyl imino ether or 4-formylbenzoyl naphthyl imino ether or 4-carboxybenzoyl phenyl imino ether or 4-hydroxynapthoyl phenyl imino ether or 4-formylnaphthoyl naphthyl imino ether or 4-carboxynaphthoyl phenyl imino ether or 4-hydroxybenzoyl 2-formylphenyl imino ether or 4-hydroxybenzoyl 2-carboxyphenyl imino ether or 4-formylbenzoyl 4-carboxyphenyl imino ether or 4-carboxybenzoyl 2-hydroxyphenyl imino ether or 4-carboxybenzoyl 2-formylphenyl imino ether or 4-carboxybenzoyl 2-carboxyphenyl imino ether or 2,4-dihydroxybenzoyl methyl imino ether or 2,4-diformylbenzoyl methyl imino ether or 2,4-dicarboxybenzoyl methyl imino ether or 2,4-dihydroxybenzoyl phenyl imino ether or 2,4-diformylbenzoyl naphthyl imino ether or 2,4-dicarboxybenzoyl phenyl imino ether or 4-hydroxynaphthoyl 2-formylnaphthyl imino ether or 4-hydroxynaphthoyl 2-carboxynaphthyl imino ether or 4-formylnaphthoyl 4-carboxynaphthyl imino ether or 4-carboxynaphthoyl 2-hydroxynaphthyl imino ether or 4-carboxynaphthoyl 2-formylnaphthyl imino ether or 4-carboxynaphthoyl 2-carboxynaphthyl imino ether or 2,4-dihydroxynaphthoyl methyl imino ether or 2,4-diformylnaphthoyl methyl imino ether or 2,4-dicarboxynaphthoyl methyl imino ether or 2,4-dihydroxynaphthoyl phenyl imino ether or 2,4-diformylnaphthoyl naphthyl imino ether or 2,4-dicarboxynaphthoyl naphthyl imino ether.

Iminoureas of the abovementioned aromatic phenols/aldehydes/carboxylic acids, such as, for example, 2-hydroxyphenyliminourea or 2-formylphenyliminourea or 2-carboxyphenyliminourea or 2-hydroxy-4-formylphenyliminourea or 2-hydroxy-4-carboxyphenyliminourea or 2-formyl-4-carboxyphenyliminourea or 2,4-dihydroxyphenyliminourea or 2,4-diformylphenyliminourea or 2,4-dicarboxyphenyliminourea or N,N′-(2-hydroxy)diphenyliminourea or N,N′-(2-formyl)diphenyliminourea or N,N′-(2-carboxy)diphenyliminourea or N,N′-(2,4-dihydroxy)diphenyliminourea or N,N′-(2,4-diformyl)diphenyliminourea or N,N′-(2,4-dicarboxy)diphenyliminourea or N,N′-(2,2′-dihydroxy)diphenyliminourea or N,N′-(2,4′-diformyl)diphenyliminourea or N,N′-(2,4′-dicarboxy)diphenyliminourea or N,N′-(2,2′-dihydroxy-4-formyl)diphenyliminourea or N,N′-(2,4′-diformyl-2-hydroxy)diphenyliminourea or N,N′-(2,4′-dicarboxy-4-formyl)diphenyliminourea or N,N′-(2-hydroxy-2′-formyl-3-carboxy)diphenyliminourea or 2-hydroxynaphthyliminourea or 2-formylnaphthyliminourea or 2-carboxynaphthyliminourea or 2-hydroxy-4-formylnaphthyliminourea or 2-hydroxy-4-carboxynaphthyl-1-iminourea or 2-formyl-4-carboxynaphthyl-1-iminourea or 2,4-dihydroxynaphthyliminourea or 2,4-diformylnaphthyliminourea or 2,4-dicarboxynaphthyliminourea or N,N′-(2-hydroxy)dinaphthyliminourea or N,N′-(2-formyl)dinaphthyliminourea or N,N′-(2-carboxy)dinaphthyliminourea or N,N′-(2,4-dihydroxy)dinaphthyliminourea or N,N′-(2,4-diformyl)dinaphthyliminourea or N,N′-(2,4-dicarboxy)dinaphthyliminourea or N,N′-(2,2′-dihydroxy)dinaphthyliminourea or N,N′-(2,4′-diformyl)dinaphthyliminourea or N,N′-(2,4′-dicarboxy)dinaphthyliminourea or N,N′-(2,2′-dihydroxy-4-formyl)dinaphthyliminourea or N,N′-(2,4′-diformyl-2-hydroxy)dinaphthyliminourea or N,N′-(2,4′-dicarboxy-4-formyl)dinaphthyliminourea or N,N′-(2-hydroxy-2′-formyl-3-carboxy)dinaphthyliminourea.

Carboxamido compounds of the abovementioned phenols/aldehydes/carboxylic acids, such as, for example, o-acetamidophenol/benzaldehyde/benzoic acid or 4-acetamidophenol/benzaldehyde/benzoic acid or 4-(N,N-diacet)aminophenol/benzaldehyde/benzoic acid or o-acetamidonaphthol/naphthaldehyde/naphthoic acid or 4-acetamidonaphthol/naphthaldehyde/naphthoic acid or 4-(N,N-diacet)-aminonaphthol/naphthaldehyde/naphthoic acid.

Ammonium salt compounds of the abovementioned aromatic phenols/aldehydes/carboxylic acids, such as, for example, p-aminophenol/benzaldehyde/benzoic acid hydrochloride or 2,4-diaminophenol/benzaldehyde/benzoic acid mono- or dihydrochloride or 4-aminophenol/benzaldehyde/benzoic acid acetate or 2,4-diacetamidophenol/benzaldehyde/benzoic acid acetate or p-aminonaphthol/naphthaldehyde/naphthoic acid hydrochloride or 2,4-diaminonaphthol/naphthaldehyde/naphthoic acid mono- or dihydrochloride or 4-aminonaphthol/naphthaldehyde/naphthoic acid acetate or 2,4-diacetamidonaphthol/naphthaldehyde/naphthoic acid acetate.

Nitro compounds of the abovementioned aromatic phenols/aldehydes/carboxylic acids, such as, for example, 4-nitrobenzaldehyde/benzoic acid/phenol or 2,4-dinitrobenzaldehyde/benzoic acid/phenol or 4-nitronaphthaldehyde/naphthoic acid/naphthol or 2,4-dinitronaphthaldehyde/naphthoic acid/naphthol.

Nitroso compounds of the abovementioned aromatic phenols/aldehydes/carboxylic acids, such as, for example, 4-nitrosophenol/benzaldehyde/benzoic acid or 4-nitroso-1,2-dihydroxyphenol or 4-nitroso-1,2-diformylbenzene or 4-nitroso-1,2-dicarboxybenzene or 4-nitrosonaphthol/naphthaldehyde/naphthoic acid or 4-nitroso-1,2-dihydroxynaphthol or 4-nitroso-1,2-diformylnaphthalene or 4-nitroso-1,2-dicarboxynaphthalene.

Nitrosamines of the abovementioned aromatic phenols/aldehydes/carboxylic acids, such as, for example, 4-(N-nitroso)aminophenol/benzaldehyde/benzoic acid or 2,4-(N,N′-dinitroso)diaminophenol/benzaldehyde/benzoic acid or 4-(N-nitroso)aminodihydroxybenzene or 4-(N-nitroso)aminodiformylbenzene or 4-(N-nitroso)aminodicarboxybenzene or N-nitroso-2-hydroxydiphenylamine or N-nitroso-2-formyldiphenylamine or N-nitroso-2-carboxydiphenylamine or N-nitroso-2,2′-dihydroxydiphenylamine or N-nitroso-2,2′-diformyldiphenylamine or N-nitroso-2,2′-dicarboxydiphenylamine or N-nitroso-N-(2-hydroxyphenyl)naphthylamine or N-nitroso-N-(2-formylphenyl)naphthylamine or N-nitroso-N-(2-carboxyphenyl)naphthylamine or N-nitroso-N-(2-hydroxyphenyl)-2′-hydroxynaphthylamine or N-nitroso-N-(2-formylphenyl)-2′-formylnaphthylamine or N-nitroso-N-(2-carboxyphenyl)-2′-carboxynaphthylamine or N-nitroso-2′-formyl-2-hydroxydiphenylamine or N-nitroso-2-formyl-2′-carboxydiphenylamine or N-nitroso-2-hydroxy-2′-carboxydiphenylamine or N-nitroso-N-(phenyl)-2-hydroxynaphthylamine or N-nitroso-N-(phenyl)-2-formylnaphthylamine or N-nitroso-N-(phenyl)-2-carboxynaphthylamine or N-nitroso-N-(2-hydroxyphenyl)-2′-formylnaphthylamine or N-nitroso-N-(2-formylphenyl)-2′-carboxynaphthylamine or N-nitroso-N-(2-carboxyphenyl)-2′-hydroxynaphthylamine.

Azides of the abovementioned phenols/aldehydes/carboxylic acids, such as, for example, 4-azidophenol/benzaldehyde/benzoic acid or 2,4-diazidophenol/benzaldehyde/benzoic acid or 4-azido-1,2-dihydroxybenzene or 4-azido-1,2-diformylbenzene or 4-azido-1,2-dicarboxybenzene or 4-azidonaphthol/naphthaldehyde/naphthoic acid or 2,4-diazidonaphthol/naphthaldehyde/naphthoic acid or 4-azido-1,2-dihydroxynaphthalene or 4-azido-1,2-diformylnaphthalene or 4-azido-1,2-dicarboxynaphthalene.

Azo compounds of the abovementioned aromatic phenols/aldehydes/carboxylic acids, such as, for example, 4-hydroxyazobenzene or 4-formylazobenzene or 4-carboxyazobenzene or 4,4′-dihydroxyazobenzene or 4,4′-diformylazobenzene or 4,4′-dicarboxyazobenzene or 2-hydroxy-4′-carboxyazobenzene or 2-formyl-4′-hydroxyazobenzene or 2-formyl-4′-carboxyazobenzene or 4-hydroxyazonaphthalene or 4-formylazonaphthalene or 4-carboxyazonaphthalene or 4,4′-dihydroxyazonaphthalene or 4,4′-diformylazonaphthalene or 4,4′-dicarboxyazonaphthalene or 2-hydroxy-4′-carboxyazonaphthalene or 2-formyl-4′-hydroxyazonaphthalene or 2-formyl-4′-carboxyazonaphthalene or 2-formylphenylazo-1-naphthalene or 2-hydroxyphenylazo-1-naphthalene or 2-carboxyphenylazo-1-naphthalene or 2,2′-dihydroxyphenylazo-2-naphthalene or 2,2′-diformylphenylazo-2-naphthalene or 2,2′-dicarboxyphenylazo-2-naphthalene or 4-hydroxyphenylazo-(4-formyl)naphthalene or 4-formylphenylazo-(4-carboxy)naphthalene or 4-carboxyphenylazo-(4-hydroxy)naphthalene.

Azoxy compounds of the abovementioned aromatic phenols/aldehydes/carboxylic acids, such as, for example, 4-hydroxyazoxybenzene or 4-formylazoxybenzene or 4-carboxyazoxybenzene or 4,4′-dihydroxyazoxybenzene or 4,4′-diformylazoxybenzene or 4,4′-dicarboxyazoxybenzene or 2-hydroxy-4′-carboxyazoxybenzene or 2-formyl-4′-hydroxyazoxybenzene or 2-formyl-4′-carboxyazoxybenzene or 2-formylphenylazoxy-1-naphthalene or 2-hydroxyphenylazoxy-1-naphthalene or 2-carboxyphenylazoxy-1-naphthalene or 2,2′-dihydroxyphenylazoxy-2-naphthalene or 2,2′-diformylphenylazoxy-2-naphthalene or 2,2′-dicarboxyphenylazoxy-2-naphthalene or 4-hydroxyphenylazoxy-(4-formyl)naphthalene or 4-formylphenylazoxy-(4-carboxy)naphthalene or 4-carboxyphenylazoxy-(4-hydroxy)naphthalene.

Sulphonic acids of the abovementioned aromatic phenols/aldehydes/carboxylic acids, such as, for example, 4-formylbenzenesulphonic acid or 4-hydroxybenzenesulphonic acid or 4-carboxybenzenesulphonic acid or 4-formylbenzene-1,3-disulphonic acid or 4-hydroxybenzene-1,3-disulphonic acid or 4-carboxybenzene-1,3-disulphonic acid or 4-formylnaphthalenesulphonic acid or 4-hydroxynaphthalenesulphonic acid or 4-carboxynaphthalenesulphonic acid or 4-formylnaphthalene-1,3-disulphonic acid or 4-hydroxynaphthalene-1,3-disulphonic acid or 4-carboxynaphthalene-1,3-disulphonic acid.

Sulphonamides of the abovementioned aromatic phenols/aldehydes/carboxylic acids, such as, for example, 4-formylbenzenesulphonamide or 4-hydroxybenzenesulphonamide or 4-carboxybenzenesulphonamide or 4-formylbenzene-1,3-disulphonamide/diamide or 4-hydroxybenzene-1,3-disulphonamide/diamide or 4-carboxybenzene-1,3-disulphonamide/diamide or 4-formylnaphthalenesulphonamide or 4-hydroxynaphthalenesulphonamide or 4-carboxynaphthalenesulphonamide or 4-formylnaphthalene-1,3-disulphonamide/diamide or 4-hydroxynaphthalene-1,3-disulphonamide/diamide or 4-carboxynaphthalene-1,3-disulphonamide/diamide, and also the derivatives of the mono- or poly-N-substituted sulphonamides, such as, for example, N-acetyl-4-hydroxybenzenesulphonamide or N-acetyl-4-formylbenzenesulphonamide or N-acetyl-4-carboxybenzenesulphonamide or N-phenyl-4-hydroxybenzenesulphonamide or N-phenyl-4-formylbenzenesulphonamide or N-phenyl-4-carboxybenzenesulphonamide or N-naphthyl-4-formylbenzenesulphonamide or N-naphthyl-4-hydroxybenzenesulphonamide or N-naphthyl-4-carboxybenzenesulphonamide or N,N-diacetyl-4-formylbenzenesulphonamide or N,N-diacetyl-4-hydroxybenzenesulphonamide or N,N-diacetyl-4-carboxybenzenesulphonamide or 4-hydroxynaphthalenesulphonamide or 4-formylnaphthalenesulphonamide or N-acetyl-4-carboxynaphthalenesulphonamide or N-phenyl-4-hydroxynaphthalenesulphonamide or N-phenyl-4-formylnaphthalenesulphonamide or N-phenyl-4-carboxynaphthalenesulphonamide or N-naphthyl-4-formylnaphthalenesulphonamide or N-naphthyl-4-hydroxynaphthalenesulphonamide or N-naphthyl-4-carboxynaphthalenesulphonamide or N,N-diacetyl-4-formylnaphthalenesulphonamide or N,N-diacetyl-4-hydroxynaphthalenesulphonamide or N,N-diacetyl-4-carboxynaphthalenesulphonamide.

Sulphonyl halides of the abovementioned aromatic phenols/aldehydes/carboxylic acids, such as, for example, 4-formylbenzenesulphonyl chloride or 4-hydroxybenzenesulphonyl chloride or 4-carboxybenzenesulphonyl chloride or 4-formylbenzene-1,3-disulphonic acid chloride/dichloride or 4-hydroxybenzene-1,3-disulphonic acid chloride/dichloride or 4-carboxybenzene-1,3-disulphonic acid chloride/dichloride or 4-formylnaphthalenesulphonyl chloride or 4-hydroxynaphthalenesulphonyl chloride or 4-carboxynaphthalenesulphonyl chloride or 4-formylnaphthalene-1,3-disulphonic acid chloride/dichloride or 4-hydroxynaphthalene-1,3-disulphonic acid chloride/dichloride or 4-carboxynaphthalene-1,3-disulphonic acid chloride/dichloride.

Sulphonic acid esters of the abovementioned aromatic phenols/aldehydes/carboxylic acids, such as, for example, dibutyl 4-hydroxy-1,2-benzenedisulphonate or dibutyl 4-hydroxy-1,2-benzenedisulphonate or dibutyl 4-formyl-1,2-benzenedisulphonate or dibutyl 4-hydroxy-1,2-naphthalenedisulphonate or dibutyl 4-hydroxy-1,2-naphthalenedisulphonate or dibutyl 4-formyl-1,2-naphthalenedisulphonate or mixed forms thereof, such as, for example, methyl butyl 4-hydroxy-1,2-benzenedisulphonate or methyl butyl 4-formyl-1,2-benzenedisulphonate or methyl butyl 4-carboxy-1,2-benzenedisulphonate or methyl butyl 4-hydroxy-1,2-naphthalenedisulphonate or methyl butyl 4-formyl-1,2-naphthalenedisulphonate or methyl butyl 4-carboxy-1,2-naphthalenedisulphonate, and also the analogous benzyl derivatives, such as, for example, benzyl 4-hydroxybenzenesulphonate or benzyl 4-formylbenzenesulphonate or benzyl 4-carboxybenzenesulphonate or their substituted derivatives, such as, for example, 2-chlorobenzyl 4-formylbenzenesulphonate or 2-chlorobenzyl 4-hydroxybenzenesulphonate or 2-chlorobenzyl 4-carboxybenzenesulphonate or benzyl 4-hydroxynapthalenesulphonate or benzyl 4-formylnaphthalenesulphonate or benzyl 4-carboxynaphthalenesulphonate or their substituted derivatives, such as, for example, 2-chlorobenzyl 4-formylnaphthalenesulphonate or 2-chlorobenzyl 4-hydroxynaphthalenesulphonate or 2-chlorobenzyl 4-carboxynaphthalenesulphonate, and also the analogous phenyl derivatives, such as, for example, phenyl 4-hydroxybenzenesulphonate or phenyl 4-formylbenzenesulphonate or phenyl 4-carboxybenzenesulphonate or 2-chlorophenyl 4-hydroxybenzenesulphonate or phenyl 4-hydroxynaphthalenesulphonate or phenyl 4-formylnaphthalenesulphonate or phenyl 4-carboxynaphthalenesulphonate or 2-chlorophenyl 4-hydroxynaphthalenesulphonate or their substituted derivatives, such as, for example, 2-chlorophenyl 4-hydroxybenzenesulphonate or 2-chlorophenyl 4-formylbenzenesulphonate or 2-chlorophenyl 4-carboxybenzenesulphonate, and also the analogous naphthyl derivatives, such as, for example, naphthyl 4-hydroxybenzenesulphonate or naphthyl 4-formylbenzenesulphonate or naphthyl 4-carboxybenzenesulphonate or their substituted derivatives, such as, for example, 2-chloronaphthyl 4-hydroxybenzenesulphonate or 2-chloronaphthyl 4-formylbenzenesulphonate or 2-chloronaphthyl 4-carboxybenzenesulphonate or 2′-chloro-4-hydroxybenzenesulphonic acid 1-methylnaphthalene ester or 2′-chloro-4-formylbenzenesulphonic acid 1-methylnaphthalene ester or 2′-chloro-4-carboxybenzenesulphonic acid 1-methylnaphthalene ester or naphthyl 4-hydroxynaphthalene-2-sulphonate or naphthyl 4-formylnaphthalene-1-sulphonate or naphthyl 4-carboxynaphthalene-2-sulphonate or their substituted derivatives, such as, for example, 2-chloronaphthyl 4-hydroxynaphthalene-1-sulphonate or 2-chloronaphthyl 4-formylnaphthalene-1-sulphonate or 2-chloronaphthyl 4-carboxynaphthalene-1-sulphonate or 2′-chloro-4-hydroxynaphthalene-1-sulphonic acid 1-methylnaphthalene ester or 2′-chloro-4-formylnaphthalene-1-sulphonic acid 1-methylnaphthalene ester or 2′-chloro-4-carboxynaphthalene-1-sulphonic acid 1-methylnaphthalene ester.

Sulphonates of the abovementioned aromatic phenols/aldehydes/carboxylic acids, such as, for example, sodium 4-formylbenzenesulphonate or sodium 4-hydroxybenzenesulphonate or sodium 4-carboxybenzenesulphonate or sodium 4-hydroxybenzene-1,2-disulphonate or sodium 4-formylbenzene-1,2-disulphonate or disodium 4-hydroxybenzene-1,2-disulphonate or disodium 4-formylbenzene-1,2-disulphonate or sodium 4-hydroxynaphthalene-1-sulphonate or sodium 4-carboxynaphthalene-2-sulphonate or sodium 4-hydroxynaphthalene-1,2-disulphonate or sodium 4-formylnaphthalene-1,2-disulphonate or disodium 4-hydroxybenzene-1,2-disulphonate or disodium 4-formylnaphthalene-1,2-disulphonate, and also the analogous mono- and disalts of the mono- and polysulphonic acid esters, such as, for example, 4-formylbenzene-1,3-disulphonic acid monobutyl ester sodium salt or 4-hydroxybenzene-1,3-disulphonic acid monobutyl ester sodium salt or 4-carboxybenzene-1,3-disulphonic acid monobutyl ester sodium salt or 4-formylnaphthalene-1,3-disulphonic acid monobutyl ester sodium salt or 4-hydroxynaphthalene-1,3-disulphonic acid monobutyl ester sodium salt or 4-carboxynaphthalene-1,3-disulphonic acid monobutyl ester sodium salt.

Hydrazides of the abovementioned aromatic phenols/aldehydes/carboxylic acids, such as, for example, 2-hydroxybenzenesulphonic acid hydrazide or 2-formylbenzenesulphonic acid hydrazide or 4-carboxybenzenesulphonic acid hydrazide or 4-carboxybenzene-1,2-disulphonic acid mono/dihydrazide or 2-hydroxybenzene-1,3,5-trisulphonic acid mono-/di-/trihydrazide or 2-formylbenzene-1,3,5-trisulphonic acid mono-/di-/trihydrazide or 2-formylbenzenesulphonic acid phenylhydrazine or 2-hydroxybenzenesulphonic acid phenylhydrazine or 3-carboxybenzenesulphonic acid phenylhydrazine or 2-formylbenzenesulphonic acid 2-chlorophenylhydrazine or 2-hydroxybenzenesulphonic acid 2-chlorophenylhydrazine or 3-carboxybenzenesulphonic acid 2-chlorophenylhydrazine or 2-formylbenzenesulphonic acid 2-formylphenylhydrazine or 2-hydroxybenzenesulphonic acid 2-formylphenylhydrazine or 3-carboxybenzenesulphonic acid 2-formylphenylhydrazine or 2-formylbenzenesulphonic acid 2-hydroxyphenylhydrazine or 2-hydroxybenzenesulphonic acid 2-hydroxyphenylhydrazine or 3-carboxybenzenesulphonic acid 2-hydroxyphenylhydrazine or 2-formylbenzenesulphonic acid 2-carboxyphenylhydrazine or 2-hydroxybenzenesulphonic acid 2-carboxyphenylhydrazine or 3-carboxybenzenesulphonic acid 2-carboxyphenylhydrazine or 2-hydroxynaphthalene-1-sulphonic acid hydrazide or 2-formylnaphthalene-1-sulphonic acid hydrazide or 4-carboxynaphthalene-1-sulphonic acid hydrazide or 4-carboxynaphthalene-1,2-disulphonic acid mono/dihydrazide or 2-hydroxynaphthalene-1,3,5-trisulphonic acid mono-/di-/trihydrazide or 2-formylnaphthalene-1,3,5-trisulphonic acid mono-/di-/trihydrazide or 2-formylnaphthalene-1-sulphonic acid phenylhydrazine or 2-hydroxynaphthalene-1-sulphonic acid phenylhydrazine or 3-carboxynaphthalene-1-sulphonic acid phenylhydrazine or 2-formylnaphthalene-1-sulphonic acid naphthylhydrazine or 2-hydroxynaphthalene-1-sulphonic acid naphthylhydrazine or 3-carboxynaphthalene-1-sulphonic acid naphthylhydrazine or 2-formylnaphthalene-1-sulphonic acid 2-chlorophenylhydrazine or 2-hydroxynaphthalene-1-sulphonic acid 2-chlorophenylhydrazine or 3-carboxynaphthalene-1-sulphonic acid 2-chlorophenylhydrazine or 2-formylnaphthalene-1-sulphonic acid 2-formylphenylhydrazine or 2-hydroxynaphthalene-1-sulphonic acid 2-formylphenylhydrazine or 3-carboxynaphthalene-1-sulphonic acid 2-formylphenylhydrazine or 2-formylnaphthalene-1-sulphonic acid 2-hydroxyphenylhydrazine or 2-hydroxynaphthalene-1-sulphonic acid 2-hydroxyphenylhydrazine or 3-carboxynaphthalene-1-sulphonic acid 2-hydroxyphenylhydrazine or 2-formylnaphthalene-1-sulphonic acid 2-carboxyphenylhydrazine or 2-hydroxynaphthalene-1-sulphonic acid 2-carboxyphenylhydrazine or 3-carboxynaphthalene-1-sulphonic acid 2-carboxyphenylhydrazine or 2-formylnaphthalene-1-sulphonic acid 2-chloronaphthylhydrazine or 2-hydroxynaphthalene-1-sulphonic acid 2-chloronaphthylhydrazine or 3-carboxynaphthalene-1-sulphonic acid 2-chloronaphthylhydrazine or 2-formylnaphthalene-1-sulphonic acid 2-formylnaphthylhydrazine or 2-hydroxynaphthalene-1-sulphonic acid 2-formylnaphthylhydrazine or 3-carboxynaphthalene-1-sulphonic acid 2-formylnaphthylhydrazine or 2-formylnaphthalene-1-sulphonic acid 2-hydroxynaphthylhydrazine or 2-hydroxynaphthalene-1-sulphonic acid 2-hydroxynaphthylhydrazine or 3-carboxynaphthalene-1-sulphonic acid 2-hydroxynaphthylhydrazine or 2-formylnaphthalene-1-sulphonic acid 2-carboxynaphthylhydrazine or 2-hydroxynaphthalene-1-sulphonic acid 2-carboxynaphthylhydrazine or 3-carboxynaphthalene-1-sulphonic acid 2-carboxynaphthylhydrazine.

Sulphonehydroxamic acids of the abovementioned aromatic phenols/aldehydes/carboxylic acids, such as, for example, 2-hydroxybenzenesulphonehydroxamic acid or 2-formylbenzenesulphonehydroxarnic acid or 2-carboxybenzenesulphonehydroxamic acid or 2-carboxybenzenetrisulphonic acid dihydroxamic acid or 2-hydroxybenzenetrisulphonic acid di-/trihydroxamic acid or 2-formylbenzenetrisulphonic acid mono-/di-/trihydroxamic acid or 2-hydroxynaphthalene-1-sulphonehydroxamic acid or 2-formylnaphthalenesulphonehydroxamic acid or 2-carboxynaphthalenesulphonehydroxamic acid or 2-carboxynaphthalenetrisulphonic acid di-/trihydroxamic acid or 2-hydroxynaphthalenetrisulphonic acid di-/trihydroxamic acid or 2-formylnaphthalenetrisulphonic acid di-/trihydroxamic acid.

Sulphonyl compounds of the abovementioned aromatic phenols/aldehydes/carboxylic acids, such as 4-formylbenzenesulphonyl chloride or 4-hydroxybenzenesulphonyl chloride or 4-carboxybenzenesulphonyl chloride or 4-(benzenesulphonyl)phenol or 4-(benzenesulphonyl)benzaldehyde or 4-(benzenesulphonyl)benzoic acid or 4-(4-hydroxybenzenesulphonyl)phenol or 4-(benzenesulphonyl)-1,3-dihydroxybenzene or 4-(benzenesulphonyl)-1,3-diformylbenzene or 4-(4-formylbenzenesulphonyl)benzaldehyde or 4-(benzenesulphonyl)-1,3-dibenzoic acid or 4-(4-carboxybenzenesulphonyl)benzoic acid or 4-(4-formylbenzenesulphonyl)phenol or 4-(4-formylbenzenesulphonyl)benzoic acid or 4-(4-carboxybenzenesulphonyl)benzaldehyde or 4-(4-hydroxybenzenesulphonyl)benzaldehyde or 4-(4-carboxybenzenesulphonyl)benzaldehyde or 4-(4-formylbenzenesulphonyl)benzoic acid or 4-(4-hydroxybenzenesulphonyl)benzoic acid or 2-hydroxybenzenesulphonylmethane or 2-formylbenzenesulphonylmethane or 2-carboxybenzenesulphonylmethane or 2-hydroxybenzenesulphonylmethyl bromide or 2-formylbenzenesulphonylmethyl bromide or 2-carboxybenzenesulphonylmethyl bromide or 4-formylnaphthalene-1-sulphonyl chloride or 4-hydroxynaphthalene-1-sulphonyl chloride or 4-carboxynaphthalene-1-sulphonyl chloride or 4-(naphthalene-1-sulphonyl)phenol or 4-(naphthalene-1-sulphonyl)benzaldehyde or 4-(naphthalene-1-sulphonyl)benzoic acid or 4-(4-hydroxynaphthalene-1-sulphonyl)phenol or 4-(naphthalene-1-sulphonyl)-1,3-dihydroxybenzene or 4-(naphthalene-1-sulphonyl)-1,3-diformylbenzene or 4-(4-formylnaphthalene-1-sulphonyl)benzaldehyde or 4-(naphthalene-1-sulphonyl)-1,3-dibenzoic acid or 4-(4-carboxynaphthalene-1-sulphonyl)benzoic acid or 4-(4-formylnaphthalene-1-sulphonyl)phenol or 4-(4-formylnaphthalene-1-sulphonyl)benzoic acid or 4-(4-carboxynaphthalene-1-sulphonyl)benzaldehyde or 4-(4-hydroxynaphthalene-1-sulphonyl)benzaldehyde or 4-(4-carboxynaphthalene-1-sulphonyl)benzaldehyde or 4-(4-formylnaphthalene-1-sulphonyl)benzoic acid or 4-(4-hydroxynaphthalene-1-sulphonyl)benzoic acid or 2-hydroxynaphthalene-1-sulphonylmethane or 2-formylnaphthalene-1-sulphonylmethane or 2-carboxynaphthalene-1-sulphonylmethane or 2-hydroxynaphthalene-1-sulphonylmethyl bromide or 2-formylnaphthalene-1-sulphonylmethyl bromide or 2-carboxynaphthalene-1-sulphonylmethyl bromide or 2-hydroxybenzenesulphonylnaphthalene or 2-formylbenzenesulphonylnaphthalene or 2-carboxybenzenesulphonylnaphthalene or 4-(2-hydroxybenzenesulphonyl)naphthaldehyde or 2-formylbenzenesulphonylnaphthaldehyde or 2-carboxybenzenesulphonylnaphthaldehyde or 2-carboxybenzenesulphonylnaphthalene or 4-(2-hydroxybenzenesulphonyl)naphthol or 2-formylbenzenesulphonylnaphthol or 2-carboxybenzenesulphonylnaphthol or 2-carboxybenzenesulphonylnaphthalene or 4-(2-hydroxybenzenesulphonyl)naphthaldehyde or 2-formylbenzenesulphonylnaphthaldehyde or 2-carboxybenzenesulphonylnaphthaldehyde or 2-hydroxynaphthalene-1-sulphonylnaphthalene or 2-formylnaphthalene-1-sulphonylnaphthalene or 2-carboxynaphthalene-1-sulphonylnaphthalene or 4-(2-hydroxynaphthalene-1-sulphonyl)naphthaldehyde or 2-formylnaphthalene-1-sulphonylnaphthaldehyde or 2-carboxynaphthalene-1-sulphonylnaphthaldehyde or 2-carboxynaphthalene-1-sulphonylnaphthalene or 4-(2-hydroxynaphthalene-1-sulphonyl)naphthol or 2-formylnaphthalene-1-sulphonylnaphthol or 2-carboxynaphthalene-1-sulphonylnaphthol or 2-carboxynaphthalene-1-sulphonylnaphthalene or 4-(2-hydroxynaphthalene-1-sulphonyl)naphthaldehyde or 2-formylnaphthalene-1-sulphonylnaphthaldehyde or 2-carboxynaphthalene-1-sulphonylnaphthaldehyde.

Thiols of the abovementioned aromatic phenols/aldehydes/carboxylic acids, such as, for example, o-, m-, p-hydroxythiophenol or 4-formylthiophenol or 4-carboxythiophenol or phenol 2,4-disulphide or benzaldehyde 2,4-disulphide or benzoic acid 2,4-disulphide or 4-hydroxythionaphthol or 4-formylthionaphthol or 4-carboxythionaphthol or naphthol 2,4-disulphide or 3-formylnaphthaldehyde 2,4-disulphide or 3-carboxynaphthalene 2,4-disulphide and their salts, such as, for example, sodium 4-hydroxythiophenolate, sodium 4-formylthiophenolate, sodium 4-carboxythiophenolate or sodium 4-hydroxythionaphtholate, sodium 4-formylthionaphtholate, sodium 4-carboxythionaphtholate

Thioethers of the abovementioned aromatic phenols/aldehydes/carboxylic acids, such as, for example, 4-(methylthio)phenol or 4-(methylthio)benzaldehyde or 4-(methylthio)benzoic acid or 4-(methylthio)naphthol or 4-(methylthio)naphthaldehyde or 4-(methylthio)naphthoic acid or 4-(phenylthio)phenol or 4-(phenylthio)benzaldehyde or 4-(phenylthio)benzoic acid or 4-(2-hydroxyphenylthio)phenol or 4-(2-hydroxyphenylthio)benzaldehyde or 4-(2-hydroxyphenylthio)benzoic acid or 4-(2-formylphenylthio)phenol or 4-(2-formylphenylthio)benzaldehyde or 4-(2-formylphenylthio)benzoic acid or 4-(2-carboxyphenylthio)benzoic acid or 4-(phenylthio)-1,2-diformylbenzene or 4-(phenylthio)-1,2-dihydroxybenzene or 4-(phenylthio)-1,2-dicarboxybenzene or 4-(4-formylphenylthio)-1,2-diformylbenzene or 4-(4-hydroxyphenylthio)-1,2-dihydroxybenzene or 4-(4-carboxyphenylthio)-1,2-dicarboxybenzene or 4-(phenylthio)-2-formylphenol or 4-(phenylthio)-2-formylbenzoic acid or 4-(phenylthio)-2-hydroxybenzoic acid or 4-(phenylthio)-2-formyl-5-hydroxybenzoic acid or 4-(naphthylthio)phenol or 4-(naphthylthio)benzaldehyde or 4-(naphthylthio)benzoic acid or 4-(phenylthio)naphthol or 4-(phenylthio)naphthylaldehyde or 4-(phenylthio)naphthylcarboxylic acid or 4-(2-chlorophenylthio)naphthol or 4-(2-chlorophenylthio)naphthylaldehyde or 4-(2-chlorophenylthio)naphthylcarboxylic acid or 4-(naphthylthio)naphthol or 4-(naphthylthio)naphthaldehyde or 4-(naphthylthio)naphthoic acid or 4-(2-hydroxynaphthylthio)naphthol or 4-(2-hydroxynaphthylthio)naphthaldehyde or 4-(2-hydroxynaphthylthio)naphthoic acid or 4-(2-formylnaphthylthio)naphthol or 4-(2-formylnaphthylthio)naphthaldehyde or 4-(2-formylnaphthylthio)naphthoic acid or (2-carboxynaphthylthio)naphthoic acid or 4-(2-chloronaphthylthio)naphthol or 4-(2-chloronaphthylthio)naphthaldehyde or 4-(2-chloronaphthylthio)naphthoic acid or 4-(naphthylthio)-2-chloronaphthol or 4-(naphthylthio)-2-chloronaphthaldehyde or 4-(naphthylthio)-2-chloronaphthoic acid or 4-(naphthylthio)-4,8-dihydroxynaphthalene or 4-(naphthylthio)-4,8-diformylnaphthalene or 4-(naphthylthio)-4,8-dicarboxynaphthalene or 4-(naphthylthio)-2-formyl-6-hydroxynaphthoic acid.

Peroxides of the abovementioned aromatic phenols/aldehydes/carboxylic acids, such as, for example, 2-hydroxyphenyl phenyl peroxide or 2-formylphenyl phenyl peroxide or 2-carboxyphenyl phenyl peroxide or 2,4-dihydroxyphenyl phenyl peroxide or 2,4-diformylphenyl phenyl peroxide or 2,4-dicarboxyphenyl phenyl peroxide or 2-hydroxyphenyl 4-hydroxyphenyl peroxide or 2-formylphenyl 4-formylphenyl peroxide or 2-carboxyphenyl 4-carboxyphenyl peroxide or 2-formyl-4-hydroxyphenyl phenyl peroxide or 2-formyl-4-carboxyphenyl phenyl peroxide or 2-hydroxy-4-carboxyphenyl phenyl peroxide or 2-formylphenyl 4-hydroxyphenyl peroxide or 2-formylphenyl 4-carboxyphenyl peroxide or 2-hydroxyphenyl 4-carboxyphenyl peroxide or 2-formylphenyl 2-hydroxy-4-carboxyphenyl peroxide or 2-hydroxyphenyl naphthyl peroxide or 2-formylphenyl naphthyl peroxide or 2-carboxyphenyl naphthyl peroxide or 2,4-dihydroxyphenyl naphthyl peroxide or 2,4-diformylphenyl naphthyl peroxide or 2,4-dicarboxyphenyl naphthyl peroxide or 2-hydroxyphenyl 4-hydroxynaphthyl peroxide or 2-formylphenyl 4-formylnaphthyl peroxide or 2-carboxyphenyl naphthyl peroxide or 2-formyl-4-hydroxyphenyl naphthyl peroxide or 2-formyl-4-carboxyphenyl naphthyl peroxide or 2-hydroxy-4-carboxyphenyl naphthyl peroxide or 2-formylnaphthyl 4-hydroxynaphthyl peroxide or 2-formylnaphthyl 4-carboxynaphthyl peroxide or 2-hydroxynaphthyl 4-carboxynaphthyl peroxide or 2-formylnaphthyl 2-hydroxy-4-carboxynaphthyl peroxide.

Benzoquinones of the abovementioned aromatic phenols/aldehydes/carboxylic acids, such as, for example, 2-hydroxybenzoquinone or 2-formylbenzoquinone or 2-carboxybenzoquinone or 5-chloro-2-hydroxybenzoquinone or 5-chloro-2-formylbenzoquinone or 5-chloro-2-carboxybenzoquinone or 2-formyl-4-hydroxybenzoquinone or 2-formyl-5-carboxybenzoquinone or 2-hydroxy-5-carboxybenzoquinone.

Polyaromatic compounds of the abovementioned aromatic phenols/aldehydes/carboxylic acids, such as, for example, 2-hydroxynaphthalene or 2-hydroxyanthracene or 2-hydroxyphenanthrene or 2-formylnaphthalene or 2-formylanthracene or 2-formylphenanthrene or 2-carboxynaphthalene or 2-carboxyanthracene or 2-carboxyphenanthrene or their substituted derivatives, such as, for example, 4-chloro-2-hydroxynaphthalene or 4-nitro-2-formylphenanthrene or 4-carboxyanthracene-2-sulphonic acid.

Isocyanates of the abovementioned aromatic phenols/aldehydes/carboxylic acids, such as, for example, 2-hydroxyphenyl isocyanate or 2-formylphenyl isocyanate or 2-carboxyphenyl isocyanate or 2-hydroxynaphthyl isocyanate or 2-formylnaphthyl isocyanate or 2-carboxynaphthylurethane or their derivatives, such as, for example, (2-formylphenyl)methylurethane or (2-hydroxyphenyl)methylurethane or (2-carboxyphenyl)methylurethane or (2-formylphenyl)phenylurethane or (2-hydroxyphenyl)phenylurethane or (2-carboxyphenyl)phenylurethane or (2-formylphenyl)-4-formylphenylurethane or (2-hydroxyphenyl)-4-hydroxyphenylurethane or (2-carboxyphenyl)-4-carboxyphenylurethane or (2-hydroxyphenyl)-4-formylphenylurethane or (2-formylphenyl)-4-carboxyphenylurethane or (2,4-diformylphenyl)phenylurethane or (2,4-dihydroxyphenyl)phenylurethane or (2,4-dicarboxyphenyl)phenylurethane or (2,4-diformylphenyl)-4-formylphenylurethane or (2,4-diformylphenyl)-4-hydroxyphenylurethane or (2,4-diformylphenyl)-4-carboxyphenylurethane or (2,4-dihydroxyphenyl)-4-hydroxyphenylurethane or (2,4-dihydroxyphenyl)-4-formylphenylurethane or (2,4-dihydroxyphenyl)-4-carboxyphenylurethane or (2,4-dicarboxyphenyl)-4-carboxyphenylurethane or (2,4-dicarboxyphenyl)-4-formylphenylurethane or (2,4-dicarboxyphenyl)-4-hydroxyphenylurethane or (2-hydroxynaphthyl)methylurethane or (2-formylnaphthyl)methylurethane or (2-carboxynaphthyl)methylurethane or (2-hydroxynaphthyl)naphthylurethane or (2-carboxynaphthyl)naphthylurethane or (2-formylnaphthyl)-4-formylnaphthylurethane or (2-hydroxynaphthyl)-4-hydroxynaphthylurethane or (2-carboxynaphthyl)-4-carboxynaphthylurethane or (2-hydroxynaphthyl)-4-formylnaphthylurethane or (2-formylnaphthyl)-4-carboxynaphthylurethane or (2,4-diformylnaphthyl)naphthylurethane or (2,4-dihydroxynaphthyl)naphthylurethane or (2,4-dicarboxynaphthyl)naphthylurethane or (2,4-diformylnaphthyl)-4-formylnaphthylurethane or (2,4-diformylnaphthyl)-4-hydroxynaphthylurethane or (2,4-diformylnaphthyl)-4-carboxynaphthylurethane or (2,4-dihydroxynaphthyl)-4-hydroxynaphthylurethane or (2,4-dihydroxynaphthyl)-4-formylnaphthylurethane or (2,4-dihydroxynaphthyl)-4-carboxynaphthylurethane or (2,4-dicarboxynaphthyl)-4-carboxynaphthylurethane or (2,4-dicarboxynaphthyl)-4-formylnaphthylurethane or (2,4-dicarboxynaphthyl)-4-hydroxynaphthylurethane.

Isothiocyanates of the abovementioned aromatic phenols/aldehydes/carboxylic acids, such as, for example, 2-hydroxyphenyl isothiocyanate or 2-formylphenyl isothiocyanate or 2-carboxyphenyl isothiocyanate or 2-hydroxynaphthyl isothiocyanate or 2-formylnaphthyl isothiocyanate or 2-carboxynaphthyl thiourethane or their derivatives, such as, for example, (2-formylphenyl)methylthiourethane or (2-hydroxyphenyl)methylthiourethane or (2-carboxyphenyl)methylthiourethane or (2-formylphenyl)phenylthiourethane or (2-hydroxyphenyl)phenylthiourethane or (2-carboxyphenyl)phenylthiourethane or (2-formylphenyl)-4-formylphenylthiourethane or (2-hydroxyphenyl)-4-hydroxyphenylthiourethane or (2-carboxyphenyl)-4-carboxyphenylthiourethane or (2-hydroxyphenyl)-4-formylphenylthiourethane or (2-formylphenyl)-4-carboxyphenylthiourethane or (2,4-diformylphenyl)phenylthiourethane or (2,4-dihydroxyphenyl)phenylthiourethane or (2,4-dicarboxyphenyl)phenylthiourethane or (2,4-diformylphenyl)-4-formylphenylthiourethane or (2,4-diformylphenyl)-4-hydroxyphenylthiourethane or (2,4-diformylphenyl)-4-carboxyphenylthiourethane or (2,4-dihydroxyphenyl)-4-hydroxyphenylthiourethane or (2,4-dihydroxyphenyl)-4-formylphenylthiourethane or (2,4-dihydroxyphenyl)-4-carboxyphenylthiourethane or (2,4-dicarboxyphenyl)-4-carboxyphenylthiourethane or (2,4-dicarboxyphenyl)-4-formylphenylthiourethane or (2,4-dicarboxyphenyl)-4-hydroxyphenylthiourethane or (2-hydroxynaphthyl)methylthiourethane or (2-formylnaphthyl)methylthiourethane or (2-carboxynaphthyl)methylthiourethane or (2-hydroxynaphthyl)naphthylthiourethane or (2-carboxynaphthyl)naphthylthiourethane or (2-formylnaphthyl)-4-formylnaphthylthiourethane or (2-hydroxynaphthyl)-4-hydroxynaphthylthiourethane or (2-carboxynaphthyl)-4-carboxynaphthylthiourethane or (2-hydroxynaphthyl)-4-formylnaphthylthiourethane or (2-formylnaphthyl)-4-carboxynaphthylthiourethane or (2,4-diformylnaphthyl)naphthylthiourethane or (2,4-dihydroxynaphthyl)naphthylthiourethane or (2,4-dicarboxynaphthyl)naphthylurethane or (2,4-diformylnaphthyl)-4-formylnaphthylthiourethane or (2,4-diformylnaphthyl)-4-hydroxynaphthylthiourethane or (2,4-diformylnaphthyl)-4-carboxynaphthylthiourethane or (2,4-dihydroxynaphthyl)-4-hydroxynaphthylthiourethane or (2,4-dihydroxynaphthyl)-4-formylnaphthylthiourethane or (2,4-dihydroxynaphthyl)-4-carboxynaphthylthiourethane or (2,4-dicarboxynaphthyl)-4-carboxynaphthylthiourethane or (2,4-dicarboxynaphthyl)-4-formylnaphthylthiourethane or (2,4-dicarboxynaphthyl)-4-hydroxynaphthylthiourethane.

Heterocyclic compounds of the abovementioned aromatic phenols/aldehydes/carboxylic acids, such as, for example, 2-hydroxypyridine or 2-hydroxyfuran or 2-hydroxythiazole or 2-hydroxypyrrole or 2-hydroxypyrazole or 2-formylpyridine or 2-formylfuran or 2-formylthiazole or 2-formylpyrrole or 2-carboxypyrazole or 2-carboxypyridine or 2-carboxyfuran or 2-carboxythiazole or 2-carboxypyrrole or 2-carboxypyrazole.

Furthermore, according to the invention all combinations of the abovementioned classes of compounds, such as, for example, 2-chloro-4-carboxybenzenesulphonic acid or 2-formyl-4-hydroxybenzoic acid or 1-amino-6-chloro-4-carboxynaphthalene-2-sulphonic acid, can be used as additives.

Additives which are preferred according to the invention are salicylic acid, vanillin, trans-cinnamaldehyde, 2,4-dimethoxybenzaldehyde or p-hydroxybenzaldehyde, and particular preference is given to salicylic acid.

The repellents and additives which can be used for the composition according to the invention are commercially available. The compositions according to the invention can be obtained by simply mixing the desired components.

According to the invention, the ratio of repellent to additive in the compositions is from 100:10% by weight to 100:200% by weight, a ratio of from 80:100 to 120:100% by weight being particularly preferred and a ratio of 100:100% by weight being very particularly preferred.

The compositions according to the invention can be employed for controlling animal pests, in particular for repelling numerous crawling insects, inter alia in the protection of stored products and materials and in the hygiene sector. They are particularly suitable for repelling ants and cockroaches. However, the compositions according to the invention are also active against normally sensitive and resistant species, such as, for example, against pests from the orders of the

Chilopoda, for example Geophilus carpophagus, Scutigera spec.;

Zygentoma, for example Lepisma saccharina;

Collembola, for example Onychiurus armatus;

Orthoptera, for example Blatta orientalis, Periplaneta americana, Leucophaea maderae, Blattella germanica, Acheta domesticus, Gryllotalpa spp., Locusta migratoria migratorioides, Melanoplus differentialis, Schistocerca gregaria;

Dermaptera, for example Forficula auricularia;

Isoptera, for example Reticulitermes spp.;

Anoplura, for example Phylloxera vastatrix, Pediculus humanus corporis, Haemtopinus spp., Linognathus spp.;

Mallophaga, for example Trichodectes spp., Damalinea spp.,

larval stages from the order of the Lepidoptera, for example Tineola bisselliella;

pests from the order of the Coleoptera, for example Anobium punctatum, Rhizopertha dominica, Acanthoscelides obtectus, Bruchidius obtectus, Hylotruptes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Demestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitalis, Costelytra zealandica;

Hymenoptera, for example Diprion spp., Hoplocampa spp., Lasius spp., Monomorium pharaonis, Vespa spp.;

Diptera, for example Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa;

Siphonaptera, for example Xenopsylla cheopis, Ceratophyllus spp.;

Arachnida, for example Scorpio maurus, Latrodectus mactans;

Acarina, for example Acarus siro, Argas spp., Omithodoros spp., Dermanyssus gallinae, Eriophyes ribis, Phyllocoptruta oleivora, Boophilus, spp., Rhipicephalus spp., Amblyomma spp., Hyalomma spp., Ixodes spp., Psooptes spp., Chorioptes spp., Sarcoptes spp., Tarsonemus spp., Bryobia praetiosa, Panonychus spp., Tetranychus spp.

Moreover, the compositions according to the invention can be used against animal parasites such as, for example, ectoparasites, for example ticks, mites, flies, lice, fleas or worms. They can be used against all parasitizing and non-parasitizing development stages of the ectoparasites.

The present invention is illustrated in more detail by the preferred embodiments below, but it is not limited to the embodiments.

### EXAMPLES

### Example 1

Determination of a Repellent Effect of Active Compounds on Treated Surfaces against Ants

The tests are carried out in crystallizing dishes (Ø 30 cm, height 10 cm) using garden ants (Lasius niger). The walls of the dishes are treated with talc to prevent the test animals from escaping. The bottom of the dish is filled with a well-moistened layer of peat of a height of about 3-4 cm. At least 5 days before the beginning of the test, the dishes are populated with 300 ants which by the time the test starts will have built passages and hiding places. The dishes prepared in this manner can be used for several weeks as long as the substances examined are insecticide-free. The ants are fed with forest honey and crystalline sugar, and the feed is removed from the dishes during the tests.

Immediately before the start of the test, 2 glass plates (5×10 cm) are placed into the dish. One plate had been treated with active compound, the other remains untreated.

The activity of the ants can be monitored, for example, visually.

What is determined is the number of ants which, within a period of 15 minutes, cross the surface to be evaluated. The activity has to be so high that at least 100 contacts are achieved. If the activity is not high enough, the time for the test has to be extended accordingly. By evaluating the number of contacts on the treated and the untreated tile, a possible repellent action can be determined.

The results of the experiments with different compositions of repellent and additive are shown below. In the compositions, repellent and additive were mixed in a ratio of 100:100% by weight. Among the additives, only vanillin had a slightly repellent effect on the ants. Compositions of Bayrepel and polyethylene glycol (PEG) or glycerol, which do not prolong the action, are shown as comparative examples.

TABLE 1
Repellent action of different additives for prolonging
the action of repellents against ants

| | % reduction of contacts after days | | | | | | | |
|---|---|---|---|---|---|---|---|---|
| Additive in 1 500 mg/m² | 1 | 2 | 3 | 4 | 7 | 8 | 9 | 10 |
| Salicylic acid | 3 | — | — | — | — | — | — | — |
| Vanillin | 63 | 46 | 65 | 83 | 51 | 35 | 0 | 0 |
| trans-Cinnamaldehyde | 0 | — | — | — | — | — | — | — |
| 2,4-Dimethoxybenzaldehyde | 0 | — | — | — | — | — | — | — |
| p-Hydroxybenzaldehyde | 23 | — | — | — | — | — | — | — |
| PEG 400 | 13 | — | — | — | — | — | — | — |
| Glycerol | 0 | — | — | — | — | — | — | — |

PEG: polyethylene glycol

TABLE 2
Repellent action of IR 3535 and DEET alone and in combination with
different additives for prolonging the action against ants.

| | Application rate: 1 500 mg a.i./m² | | % reduction of contacts after days | | | | | | | |
|---|---|---|---|---|---|---|---|---|---|---|
| Ex. | Repellent | Additive | 1 | 2 | 3 | 4 | 7 | 8 | 9 | 10 |
| 1 | IR 3535 | — | 98 | 91 | 29 | 0 | 0 | 0 | — | 0 |
| 2 | IR 3535 | + salicylic acid | 98* | 72* | 65* | 97* | 65* | 86* | — | 87* |
| 3 | IR 3535 | + vanillin | 81 | 81 | 74 | 79 | 36 | 50 | — | 75 |
| 4 | IR 3535 | + trans-cinnamaldehyde | 100 | 89 | 86 | 52 | 25 | 3 | — | 0 |
| 5 | DEET | — | 100 | 76 | 0 | 0 | 27 | 14 | — | 0 |
| 6 | DEET | + salicylic acid | 94 | 97 | 100 | 97 | 97 | 80 | — | 37 |
| 7 | DEET | + vanillin | 100 | 99 | 97 | 95 | 85 | 48 | — | 38 |
| 8 | DEET | + trans-cinnamaldehyde | 100 | 96 | 90 | 83 | 49 | 33 | — | 73 |

* — The results vary strongly; however, there is a clear positive effect

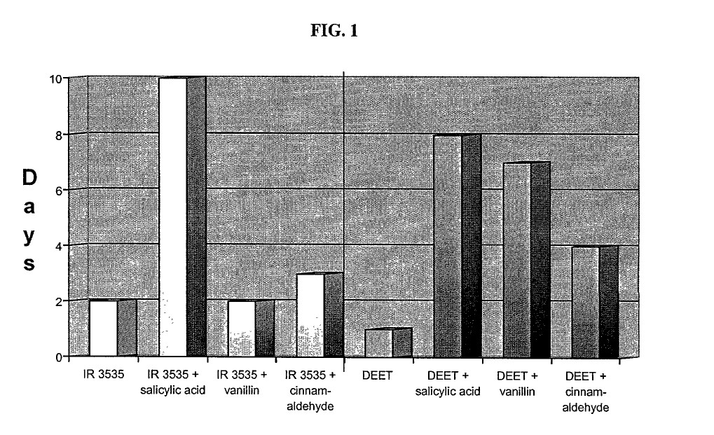

The graph of the repellent action (80-100% reduction of contacts) of IR 3535 and DEET alone and in combination with different additives is shown in FIG. 1.

TABLE 3
Repellent action of KBR 3023 (Bayrepel) alone and in combination
with different additives for prolonging the action against ants

| | Application rate: | | | | | | | | | | | | | | |
|---|---|---|---|---|---|---|---|---|---|---|---|---|---|---|---|
| Ex. | 1 500 mg a.i./m² | | % reduction of contacts after days | | | | | | | | | | | | |
| 9 | Repellent | + Additive | 1 | 2 | 3 | 4 | 7 | 8 | 9 | 10 | 11 | 14 | 15 | 16 | 17 |
| 10 | KBR | — | 100 | 98 | 99 | 97 | 76 | 53 | 77 | 47 | 40 | 11 | 7 | 0 | 12 |
| | 3023 | | | | | | | | | | | | | | |
| 11 | KBR | + salicylic acid | 100 | 100 | 99 | 100 | 100 | 98 | 96 | 97 | 98 | 93 | 95 | 72 | 60 |
| | 3023 | | | | | | | | | | | | | | |
| 12 | KBR | + vanillin | 100 | 100 | 99 | 99 | 87 | 71 | 82 | 92 | 34 | 11 | — | — | — |
| | 3023 | | | | | | | | | | | | | | |
| 13 | KBR | + trans-cinnam- | 100 | 97 | 96 | 94 | 80 | 92 | 89 | 86 | 86 | 42 | — | — | — |
| | 3023 | aldehyde | | | | | | | | | | | | | |
| 14 | KBR | + 2,4-dimethoxy- | 98 | 100 | 96 | 93 | 80 | 96 | 83 | 66 | 66 | — | — | — | — |
| | 3023 | benzaldehyde | | | | | | | | | | | | | |
| 15 | KBR | + p-hydroxy- | 89 | 93 | 92 | 69 | 87 | 89 | 76 | 50 | — | — | — | — | — |
| | 3023 | benzaldehyde | | | | | | | | | | | | | |
| Comp. | KBR | + PEG 400 | 98 | 96 | 95 | 79 | — | — | — | — | — | — | — | — | — |
| Ex. 1 | 3023 | | | | | | | | | | | | | | |
| Comp. | KBR | + glycerol | 100 | 100 | 100 | 96 | 14 | 0 | — | — | — | — | — | — | — |
| Ex. 2 | 3023 | | | | | | | | | | | | | | |

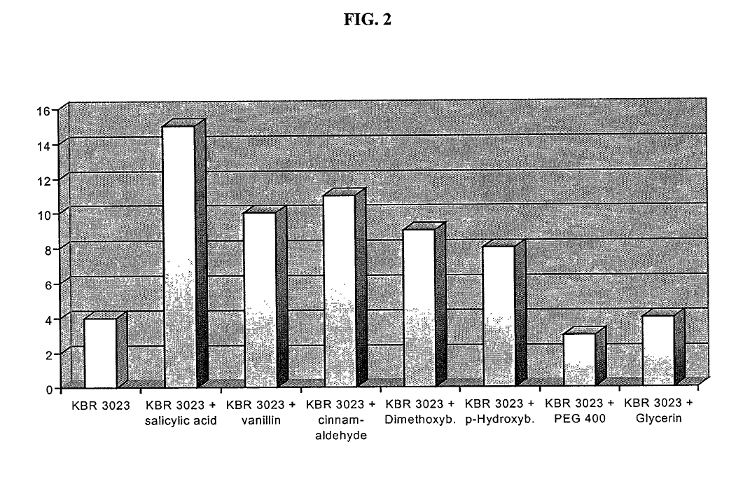

The graph of the repellent action (80-100% reduction of contacts) of KBR 3023 (Bayrepel) alone and in combination with different additives is shown in FIG. 2.

### Example 2

Repellent Action of KBR 3023 against Cockroaches

The repellent action of KBR 3023 was tested against German cockroaches (Blattella germanica), 5th larval stage. Additionally, it was tested whether the aromatic aldehyde vanillin can improve residual action.

The tests were carried out in cardboard test boxes (60×40 cm) which were open at the top. The walls of the boxes are treated with talc to prevent the test animals from escaping. On one of the long sides of the box, a white cardboard hut is erected as a hiding place (12×6.5×2.5 cm), at a distance of 3 cm from the wall. The cockroaches can enter the hiding place through an opening of a width of 2 cm and a height of 1 cm on the side of the hiding place which faces the wall. 24 hours prior to the start of the test, the boxes are populated with 50 cockroaches, most of which have moved into the hiding place by the time the test starts.

Above the test box, two infrared lamps are mounted on a support such that the red light shines directly into the test boxes.

On the day of the test, immediately prior to the start of the test, 2 tiles (15×15 cm) are placed in the box. One tile had been treated beforehand with active compound, the other remains untreated. To lure the cockroaches onto the tiles, a Lupolen plug (diameter 1.5 cm, height 0.5 cm) with oatmeal dissolved in water is placed behind the tiles. The test room is then blacked out completely and only illuminated by the infrared light.

The activity of the cockroaches that now begins can be monitored, for example, visually (if appropriate with the aid of night vision scopes).

What is determined is the number of cockroaches which, over a period of one hour and twenty minutes after the start of the test, cross the middle third of the tiles. By evaluating the number of contacts on the treated and the untreated tile, a possible repellent action can be determined.

The results of the experiments with a composition of Bayrepel and vanillin are shown below. In the composition, repellent and additive were mixed in a ratio of 100:100 % by weight.

TABLE 4
Repellent action of KBR 3023 alone and in combination with vanillin for
prolonging the action against Blattella germanica L 5 on glazed tiles.

| Application rate: | | | | | | | | | | | | |
|---|---|---|---|---|---|---|---|---|---|---|---|---|
| in each case | | | | | | | | | | | | |
| 3000 mg of a.i./m² | | % reduction of contacts after days | | | | | | | | | | |
| Repellent | + Additive | 7 | 10 | 11 | 13 | 16 | 18 | 20 | 23 | 28 | 32 | 35* |
| KBR | — | 100 | 98 | 91 | 74 | 49 | 16 | 0 | 5 | 0 | 0 | 8 |
| 3023 | | | | | | | | | | | | |
| KBR | + vanillin | 100 | 97 | 100 | 99 | 99 | 98 | 93 | 95 | 99 | 94 | 76 |
| 3023 | | | | | | | | | | | | |

* — Terminated after 35 days

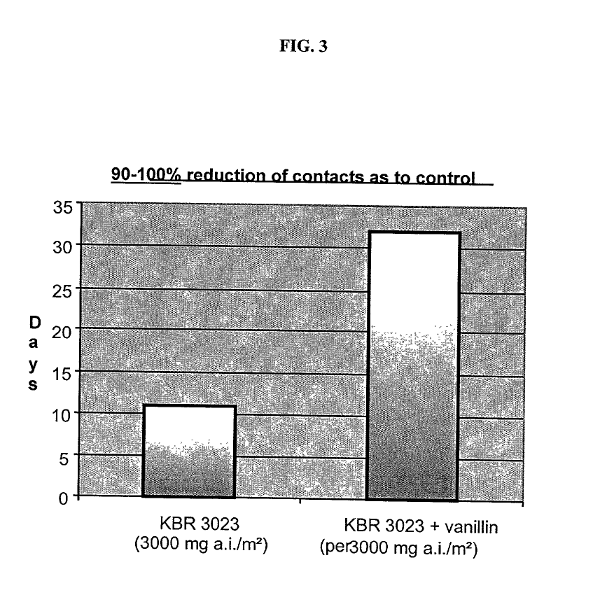

The graph of the repellent action (90-100% reduction of contacts) of KBR 3023 alone and in combination with vanillin, against Blattella is shown in FIG. 3.

1. Composition, comprising a repellent and an additive, characterized in that the additive is selected from the group consisting of phenol, benzaldehyde, benzoic acid or derivatives thereof and is present in a ratio of from 10:100 to 200:100% by weight to the repellent, with the proviso that the repellent is not N,N-diethyl-m-toluamide (DEET).

2. Composition according to claim 1, characterized in that the ratio of additive to repellent is from 80:100 to 120:100% by weight.

3. Composition according to claim 1, characterized in that the ratio of additive to repellent is 100:100% by weight.

4. Composition according to any of the preceding claims, characterized in that the repellent is selected from the group consisting of Merck 3535 (IR 3535) and 1-(2-methylpropyloxycarbonyl)-2-(hydroxyethyl)-piperidine (Bayrepel®).

5. Composition according to claim 4, characterized in that the repellent is 1-(2-methylpropyloxycarbonyl)-2-(hydroxyethyl)-piperidine (Bayrepel®).

6. Composition according to any of the preceding claims, characterized in that the additive is selected from the group consisting of salicylic acid, vanillin, trans-cinnamaldehyde, 2,4-dimethoxybenzaldehyde and p-hydroxybenzaldehyde.

7. Composition according to claim 6, characterized in that the additive is salicylic acid.

8. Composition according to any of the preceding claims, characterized in that the repellent is 1-(2-methylpropyloxycarbonyl)-2-(hydroxyethyl)-piperidine (Bayrepel®) and the additive is salicylic acid.

9. Use of the composition according to any of claims 1 to 8 for repelling crawling harmful insects.

10. Use according to claim 9, characterized in that the crawling harmful insects are ants or cockroaches.

11. Method for repelling crawling harmful insects, comprising applying a composition according to any of claims 1 to 8 onto a surface which is not to be crossed by the insects.

12. Method according to claim 11, characterized in that the crawling harmful insects are ants or cockroaches.

13. Use of a composition comprising N,N-diethyl-m-toluamide (DEET) and an additive according to any of claims 1 to 3, 6 or 7 for repelling crawling harmful insects.

14. Use according to claim 13, characterized in that the crawling harmful insects are ants or cockroaches.

15. Method for repelling crawling harmful insects, comprising applying a composition comprising N,N-diethyl-m-toluamide (DEET) and an additive according to any of claims 1 to 3, 6 or 7 onto a surface which is not to be crossed by the insects.

16. Method according to claim 15, characterized in that the crawling harmful insects are ants or cockroaches.
